(19) United States
(12) Patent Application Publication
(10) Pub. No.: US 2010/0112968 A1
(43) Pub. Date: May 6, 2010

(54) METHOD AND APPARATUS FOR CLONING CONTENTS OF A SOURCE RADIO INTO A TARGET RADIO

(75) Inventors: Craig J. Mackey, Sunrise, FL (US); Normarie Garica, Plantation, FL (US); Donald J. Phelps, Weston, FL (US); Debra D. Rodriguez, Pembroke Pines, FL (US)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 12/261,739

(22) Filed: Oct. 30, 2008

(51) Int. Cl. H04B 1/18

(52) U.S. Cl. 455/186.1

(57) ABSTRACT

A method and apparatus for cloning contents of a source radio (104) into a target radio (106) are disclosed. The method (300) includes determining (302) a configurable flash-code (210) of the source radio. The configurable flash-code (210) is configured from a first purchase flash-code that represents a first set of features employed by a user associated with the source radio. The method then includes receiving (304) a second purchase flash-code (212) from the target radio. The second purchase flash-code (212) represents a second set of features purchased in the target radio. The method further includes determining (306) whether the first set of features associated with the configurable flash-code (210) is at least a subset of the second set of features associated with the second purchase flash-code (212). The method then includes cloning (308) the contents of the source radio into the target radio, when the first set of features associated with the configurable flash-code (210) is at least a subset of the second set of features associated with the second purchase flash-code (212).

### FIELD OF THE DISCLOSURE

The present disclosure relates generally to a radio system and more particularly to a method and apparatus for cloning contents of a source radio into a target radio.

### BACKGROUND

Typically, a radio communication system includes a plurality of radios that communicate with one another over a radio frequency communication link. Each of the radios includes a configuration data which identifies communication options. For example, the configuration data may identify an operating frequency and a private line associated with the radio. In certain cases, it may be necessary to set a configuration of one radio to a configuration of another radio so as to customize features between the radios.

Conventionally, radios are configured to operate in a particular radio communication system. In general, the radios are configured with a pre-defined set of features customized by a factory for each user or a group of users. Such a pre-defined set of features is configured by hard coding a flash-code in the radio when the user first purchases the radio. Such a flash-code is typically referred to as a purchased flash-code. The purchased flash-code includes a plurality of bits, wherein each bit or a group of bits corresponds to a feature selected by the user. However, during a process of exchanging configurable data between the radios, known as radio cloning, the radios should have the same purchased flash-codes. Radio functionality which depends on the purchased flash-code cannot be cloned to another radio that does not contain the same functionality or the purchased flash-code. In such a case, the user may have to employ Digital Signal Processing (DSP) to determine the functionality or features to be brought over during cloning. Thus, the cloning process tends to be a cumbersome to implement, and difficult to maintain, especially, when cloning is performed for a plurality of radios.

Accordingly, there exists a need for cloning radios even when the radios are configured with non-identical purchased flash-codes.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system for cloning contents of a source radio into a target radio, in accordance with some embodiments.

FIG. 2 is a block diagram of a Computer Programmable Device (CPD), in accordance with some embodiments.

FIG. 3 is a flowchart of a method for cloning contents of the source radio into the target radio, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure is directed towards a method for cloning contents of a source radio into a target radio. The method includes determining a configurable flash-code of the source radio. The configurable flash-code is configured from a first purchase flash-code that represents a first set of features employed by a user associated with the source radio. The method then includes receiving a second purchase flash-code from the target radio. The second purchase flash-code represents a second set of features purchased in the target radio. The method further includes determining whether the first set of features associated with the configurable flash-code is at least a subset of the second set of features associated with the second purchase flash-code. The method then includes cloning the contents of the source radio into the target radio, when the first set of features associated with the configurable flash-code is at least a subset of the second set of features associated with the second purchase flash-code.

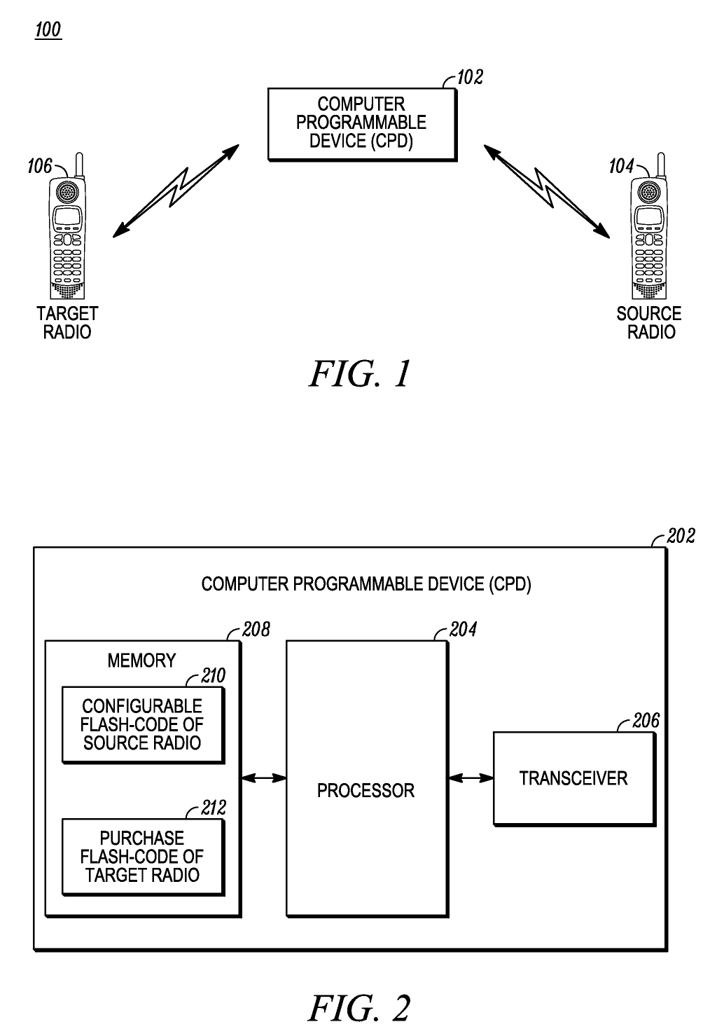

FIG. 1 is a block diagram of a communication system for cloning contents of a source radio 104 into a target radio 106, in accordance with some embodiments. A radio may be a battery powered portable public safety radio that operates in a terrestrial trunked radio (TETRA) system, an Association of Public Safety Communications Officials (APCO) system, or any other similar system. In general, the radio may be any high tier radio that is substantially used as a marketing model which sells add-on software features in addition to the hardware in the radio.

In accordance with the embodiment, the radio may be a wireless device, a mobile station, a battery operated portable two-way hand-held radio, a mobile radio, or any similar device that can transmit and receive signals. The radio may be configured to operate according to any of a number of different 2G, 3G and 4G wireless communication technologies, or according to any other radio standards.

In accordance with the embodiment, the radio is initially hard coded with a binary number, known as a purchase flash-code, which indicates features that are actually purchased in the radio. For example, the purchase flash-code may include 16 bits, wherein each bit or a group of bits represents a feature that is purchased and added to the radio. The feature may include type of signaling, number of people handling the call, call list, or other similar applications.

The purchase flash-code is programmed by a factory/manufacturer during manufacturing the radio or before shipping the products to an individual user or users within, for example, a public safety environment. The public safety environment may include fire fighters, police officers, paramedics or the like.

In accordance with the embodiment, the radio includes another binary number, known as a configurable flash-code, which is automatically configured from the purchase flash-code based on the applications navigated or interacted by the user. For example, the configurable flash-code includes 16 bits, wherein each bit is initially turned OFF, for example bit ‘0’, by default. Further, based on the user using the features, the corresponding bit in the configurable flash-code is turned ON, for example bit ‘1’. The configurable flash-code represents the features that are purchased and also used by the user associated with the radio.

In accordance with the embodiment, the radio may be a source radio 104 or a target radio 106. The source radio 104 is the one where the configurable flash-code is configured, from the purchase flash-code, based on the user using the applications/features in the radio. The target radio 106 is the one which is cloned or configured with the contents of the source radio 104. The contents may include at least one of configurable data and customized parameters of the source radio. In one embodiment, the source radio and the target radios are government and public safety radios, where the source radio may be a part of one system and the target radio may be a part of another system.

In accordance with the embodiment, the computer programmable device (CPD) 102 includes computer programming software (CPS) that monitors the fields or parameters that are gained access in the source radio 104, and accordingly determines the features, associated with the fields, used in the source radio 104. The CPS then configures the configurable flash-code in the source radio that represents the set of features used in the source radio 104.

During the process of cloning, the computer programmable device (CPD) 102 obtains the purchase flash-code, from the target radio 106 that represents the set of features purchased in the target radio 106. For example, the purchase flash-code of the target radio is non-identical to the purchase flash-code of the source radio. Upon receiving the purchase flash-code, the computer programmable device 102 compares the purchase flash-code of the target radio 106 with the configurable flash-code of the source radio 104. The computer programmable device 102 then determines whether the set of features associated with the configurable flash-code is a subset of the set of features associated with the purchase flash-code of the target radio 106.

If the set of features associated with the configurable flash-code is a subset of the set of features associated with the purchase flash-code of the target radio 106, the computer programmable device receives the configurable data from the source radio 104. The computer programmable device then clones the received configurable data into the target radio 106. Thus, cloning is performed over the radios even when the radios are configured with non-identical purchased flash-codes.

FIG. 2 is a block diagram of a Computer Programmable Device (CPD) 202, in accordance with some embodiments. The exemplary components include a processor 204, a memory 208, and a transceiver 206. Although not shown, the processor 204 may be coupled to an input device and an output device. In one embodiment, the input device may be used to connect the CPD to the radios such as the source radio 104 and the target radio 106 of FIG. 1.

In accordance with an embodiment, the memory 208 is coupled to the processor 204 to store the configurable flash-code 210 and the purchase flash-code 212, received from the source radio 104 and the target radio 106 respectively. In one embodiment, the memory 208 may be a flash memory storing the updated flash-codes received from the source and target radios. It should be noted that the memory 208 is not limited to storing only the configurable flash-code 210 of the source radio 104. It may also store the purchase flash-code and other parameters of the source radio 104. In one embodiment, the memory 208 includes a list of configurable flash-codes and a list of purchase flash-codes of a plurality of radios that are operating in a particular public safety environment. Further, each of the configurable and purchase flash-codes is associated with a corresponding identification of the radio from which the respective flash-code is received.

In accordance with the embodiment, the transceiver 206 coupled to the processor 204 enables the CPD 202 to communicate with at least one radio. The communication may be a wireless communication or a wire-line communication. In general, the transceiver 206 may provide wireless communication due to mobile nature of the CPD 202. An exemplary function of the CPD 202 as represented by the block diagram, upon reception of wireless signals via the antenna (not shown), the transceiver 206 demodulates the communication signals to recover incoming information, such as voice and/or data, transmitted by the wireless signals. Specifically, the incoming information contains flash-codes and other configurable data for cloning the target radio 106.

In accordance with the embodiment, the transceiver 206 receives cloning data from the source radio, and transmits the received cloning data to the target radio. The cloning data includes at least one of configurable data and customized parameters of the source radio.

Operationally, the processor 204 is coupled to the memory 208, and the transceiver 206. The processor 204 may perform various operations to store, manipulate and retrieve the flash-codes in the memory 208.

In accordance with the embodiment, the processor 204 tracks the fields/parameters that are gained access due to purchase flash-code in the source radio 104. Based on the tracking, the processor 204 determines the features used by the user associated with the source radio 104. Further, the processor 204 configures a flash-code, known as the configurable flash-code in the source radio 104, based on the features used. The configurable flash-code 210 represents a set of features that are purchased and also used by the user associated with source radio 104. The configurable flash-code 210 indicates the set of features that may be a subset of the features purchased in the source radio 104.

During the process of cloning the configurable data into the target radio 106, the processor 204 first determines a configurable flash-code 210 of the source radio. The processor 204 then compares the determined configurable flash-code 210 with the purchase flash-code 212 of the target radio 106, and further determines whether the set of features associated with the configurable flash-code 210 is a subset of the features associated the purchase flash-code of the target radio 106. For example, the processor determines whether the bits in the configurable flash-code 210 are subset of bits in the purchase flash-code 212 of the target radio 106.

In one embodiment, the processor 204 compares a plurality of activated bits of the configurable flash-code 210 with a plurality of activated bits of the purchase flash-code 212, wherein each of the activated bits is associated with a corresponding feature. Further, the processor 204 determines whether the activated bits of the configurable flash-code 210 are a subset of the activated bits of the purchase flash-code 212.

Upon determining that the set of features associated with the configurable flash-code 210 is a subset of the features associated the purchase flash-code of the target radio 106, the processor 204 receives the configurable data from the source radio 104, and copies or clones the received configurable data into the target radio 106. Basically, the processor 204 customizes the features in the target radio 106 as that of the source radio 104. It is should be noted that the cloning is not limited to one target radio. The processor 204 may clone the configurable data into a plurality of target radios coupled to the CPD 202.

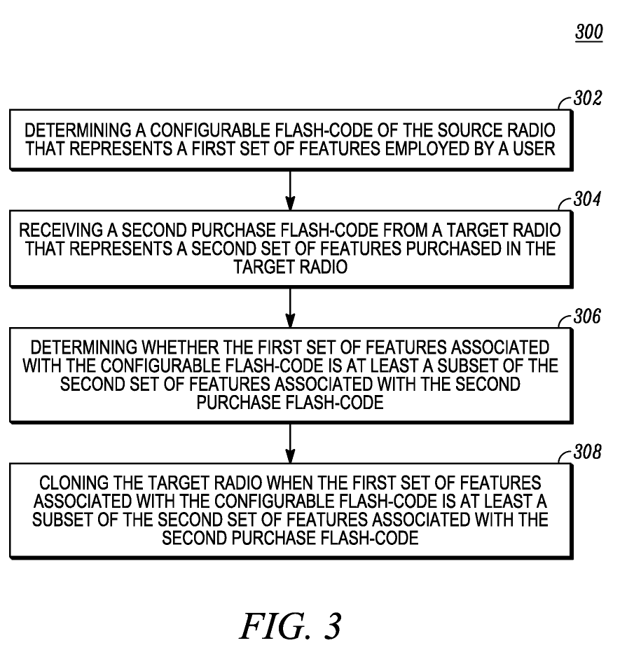

FIG. 3 is a flowchart of a method 300 for cloning contents of a source radio 104 into a target radio 106, in accordance with some embodiments. It is to be noted that the method 300 is not limited to only one target radio 106. The method 300 may be employed for cloning contents of a source radio 104 into a plurality of target radios. Please note that the method 300 is described from the perspective of a Computer Programmable Device (CPD) 102 shown in FIG. 1. Referring to FIG. 3, the method 300 begins with a step of determining 302 a configurable flash-code of the source radio from a purchase flash-code embedded in the source radio. The configurable flash-code represents a set of features, for example, a first set of features, employed by a user. The configurable flash-code is configured from a purchased flash-code that is hard coded by the manufacturers at the time of purchase of the source radio 104.

In one embodiment, the computer programmable device (CPD) 102 first determines a set of features, used by the user, from a set of features, for example, a third set of features, purchased in the source radio 104. The CPD 102 then automatically calculates or determines the configurable flash-code based on the determined features used by the user. The configurable flash-code includes a binary number that represents the first set of features used by the user. Also, the CPD 102 may manually modify the configurable flash-code to deactivate at least one feature from the first set of features employed by the user. This provides the option of modifying the configurable flash-code prior to cloning the contents into the target radio 106. In another embodiment, the source radio 104 automatically configures the configurable flash-code based on the user gaining access to at least one field associated with the first purchase flash-code. The at least one field represents at least one feature of the first set of features associated with the source radio.

The method then continues with a step of CPD 102 receiving 304 a second purchase flash-code from the target radio 106. The second purchase flash-code represents a set of features, for example, a second set of features, purchased in the target radio 106. In one embodiment, the second set of features may represent the features that are purchased but are not used by a user associated with the target radio.

The method then continues with a step of CPD 102 determining 306 whether the first set of features associated with the configurable flash-code is at least a subset of the second set of features associated with the second purchase flash-code. The CPD 102 receives the configurable flash-code and determines the first set of features that are used by the user associated with source radio 104. Similarly, the CPD 102 receives the second purchase flash-code of the target radio 106, which indicates the second set of features purchased in the target radio 106. Further, the CPD 102 compares the configurable flash-code of the source radio 104 with the purchase flash-code of the target radio 106, and determines whether the first set of features associated with the configurable flash-code is a subset of the second set of features associated with the purchase flash-code of the target radio 106.

At an implementation level, the CPD 102 first compares a plurality of activated bits of the configurable flash-code with a plurality of activated bits of the purchase flash-code. Each of the activated bits is associated with a corresponding feature. The CPD 102 then determines whether the activated bits of the configurable flash-code are a subset of the activated bits of the purchase flash-code.

The method then continues with a step of CPD 102 cloning 308 the contents of the source radio 104 into the target radio 106, when the first set of features associated with the configurable flash-code is at least a subset of the second set of features associated with the second purchase flash-code. The contents include configurable data of the source radio 104. In one embodiment, the CPD 102 customizes features of the target radio 106, to be similar with the first set of features of the source radio 104. Thus, the method 300 provides an option of cloning the target radio 106 even when the purchase flash-code of the target radio 106 is non-identical to the purchase flash-code of the source radio 104.

Thus, the method employs configurable flash-code of the source radio for cloning the configurable data of the source radio 104 into the target radio 106 having hard coded purchase flash-code.

The cloning technique is particularly advantageous to the public safety arena where the purchase flash-code of each radio is different from one another. Also, the cloning technique provides an additional advantage of pre-buying the features for the current source radio, and later updating the features in the additional radios, for example, target radios, based on requirements in the arena.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for cloning contents of a source radio into a target radio, the method comprising:
determining a configurable flash-code of the source radio from a first purchase flash-code embedded in the source radio, wherein the configurable flash-code represents a first set of features employed by a user associated with the source radio;
receiving a second purchase flash-code from the target radio, wherein the second purchase flash-code represents a second set of features purchased in the target radio;
determining whether the first set of features associated with the configurable flash-code is at least a subset of the second set of features associated with the second purchase flash-code; and
cloning the contents of the source radio into the target radio, when the first set of features associated with the configurable flash-code is at least a subset of the second set of features associated with the second purchase flash-code.

2. The method of claim 1, wherein determining a configurable flash-code of the source radio comprises:
receiving the first purchase flash-code of the source radio, wherein the first purchase flash-code represents a third set of features purchased in the source radio; and
determining that at least one feature of the third set of features is employed by a user associated with the source radio, wherein the at least one feature is a part of the first set of features of the source radio; and
configuring a configurable flash-code from the first purchase flash-code based on the at least one feature employed by the user associated with the source radio.

3. The method of claim 1, wherein the configurable flash-code is configured automatically based on the user gaining access to at least one field associated with the first purchase flash-code, wherein the at least one field represents at least one feature of the first set of features associated with the source radio.

4. The method of claim 1, wherein the configurable flash-code is modified manually to deactivate at least one feature from the first set of features employed by the user.

5. The method of claim 4, wherein the configurable flash-code is modified prior to cloning the target radio.

6. The method of claim 1, wherein the first purchase flash-code represents a third set of features purchased in the source radio.

7. The method of claim 6, wherein the first set of features of the source radio is at least a subset of the third set of features purchased in the source radio.

8. The method of claim 1, wherein determining whether the first set of features associated with the configurable flash-code is at least a subset of the second set of features associated with the second purchase flash-code comprises:
comparing a plurality of activated bits of the configurable flash-code with a plurality of activated bits of the second purchase flash-code, wherein each of the activated bits is associated with a corresponding feature; and
determining whether the activated bits of the configurable flash-code are a subset of the activated bits of the second purchase flash-code.

9. The method of claim 1, wherein cloning the contents of the source radio into the target radio comprises customizing the second set of features in the target radio based on the first set of features employed by the user associated with the source radio.

10. The method of claim 1, wherein cloning the contents of the source radio into the target radio comprises exchanging configurable data between the source radio and the target radio.

11. A programming device for cloning a target radio, the programming device comprising:
a memory for storing a configurable flash-code associated with a source radio, wherein the configurable flash-code, configured from a first purchase flash-code, represents a first set of features employed by a user associated with the source radio, and the memory for storing a second purchase flash-code from the target radio, wherein the second purchase flash-code represents a second set of features purchased in the target radio; and
a processor for cloning the target radio when the first set of features associated with the configurable flash-code is at least a subset of the second set of features associated with the second purchase flash-code.

12. The programming device of claim 11 further comprising a transceiver for receiving cloning data from the source radio, and transmitting the received cloning data to the target radio.

13. The programming device of claim 12, wherein the cloning data is at least one of a) configurable data and b) customized parameters of the source radio.

14. The programming device of claim 11, wherein the processor determines the configurable flash-code from the first purchase flash-code, based on the first set of features employed by the user associated with the source radio.

15. The programming device of claim 14, wherein the first set of features is at least a subset of a third set of features associated with the first purchase flash-code of the source radio.

16. A system for cloning contents of one radio into at least one other radio, the system comprising:
a source radio including a configurable flash-code determined from a purchase flash-code, wherein the purchase flash-code represents a first set of features purchased for the source radio, and the configurable flash-code represents a second set of features employed by a user associated with the radio;
a target radio including a purchase flash-code, wherein the purchase flash-code represents a third set of features purchased for the target radio; and
a programming device, coupled between the source radio and the target radio, for cloning the contents of the source radio into the target radio when the second set of features associated with the configurable flash-code is at least a subset of the third set of features associated with the second purchase flash-code.

17. The system of claim 16 further comprising a plurality of target radios coupled to the programmable device for cloning the contents of the source radio into each of the target radios.

18. The system of claim 16, wherein the source radio and the target radios are government and public safety radios.

19. The system of claim 16, wherein the source radio is a part of one system and the target radio is a part of another system.

20. The system of claim 16, wherein the source radio and the target radios operate in at least one of a TETRA system and an APCO system.
